(19) United States
(12) Patent Application Publication
(10) Pub. No.: US 2011/0138939 A1
(43) Pub. Date: Jun. 16, 2011

(54) Fixed Moment Arm Combustion Apparatus

(76) Inventor: William James Carr, San Jose, CA (US)

(21) Appl. No.: 12/727,264

(22) Filed: Mar. 19, 2010

Related U.S. Application Data
(60) Provisional application No. 61/285,544, filed on Dec. 11, 2009.

(51) Int. Cl. F16H 19/04

(52) U.S. Cl. 74/32

(57) ABSTRACT

An apparatus for converting linear reciprocal motion to rotary motion is provided. The apparatus comprises a reciprocating assembly comprising a reciprocating component and a reciprocating rod. The reciprocating component is rigidly attached to the reciprocating rod and is supported by a housing. The reciprocating rod is slidably connected to an idler gear via a guide pin. Multiple gear racks are disposed on the reciprocating rod for transmitting motion to one or more gearing elements. The gearing elements are disposed on opposing sides of the reciprocating rod and are in alternate mesh with the gear racks to transmit the motion to the idler gear. Each of the gearing elements and each of the gear racks together define a fixed moment arm. The gearing elements mesh with the idler gear rigidly mounted on a power shaft to convert linear reciprocal motion of the reciprocating assembly to rotary motion of the power shaft.

### CROSS REFERENCE TO RELATED APPLICATIONS

This application claims the benefit of provisional patent application No. 61/285,544 titled “Fixed Moment Arm Combustion Engine”, filed on Dec. 11, 2009 in the United States Patent and Trademark Office.

The specification of the above referenced application is incorporated herein by reference in its entirety.

### BACKGROUND

Conventional reciprocating engines consist of a cylinder body and a piston with a connecting rod and a crank assembly. During operation of a conventional reciprocating engine, the connecting rod and crank assembly convert linear reciprocal motion to rotary motion. A mixture of fuel and air is ignited in the cylinder body and a combustion force is produced as a result of the ignition of the mixture of fuel and air. The piston executes linear reciprocal motion. The connecting rod is displaced, horizontally and vertically, along a vertical plane when the piston executes the linear reciprocal motion. This displacement of the connecting rod angularly displaces the combustion force while transmitting the combustion force to the crank assembly. Furthermore, the angular displacement of the combustion force is varying with respect to the position of the piston in the cylinder body. Thus, a variable moment arm exists and subsequently a constantly varying component of the combustion force is transmitted to the crank assembly over a cycle of operation of the conventional reciprocating engine. The displacement of the connecting rod allows only a component of the combustion force to be transmitted to the crank assembly and hence results in wastage of energy and high fuel consumption for a rated power output.

Consider a conventional reciprocating engine with a fixed stroke length, for example, a two inch stroke length. The length of the variable moment arm, approximately averaging 0.333 inch moment arm for a two inch stroke length, would be a varying one, for example, 0 inch to 1 inch, at different instants of operation. A 2″ stroke average moment arm for the crank/piston relationship is 0.333″. This is achieved by taking the moment arm at the start, which is 0, the moment arm at the middle, which is 1, and the moment arm at the finish, which is 0. On adding these moment arms together and dividing by three, the average moment arm is 0.333″. The moment arm here is a variable moment arm due to its varying length, that is, 0 inch to 1 inch. Hence, the varying length of the variable moment arm in a conventional reciprocating engine allows only a component of the combustion force to be transmitted to the power shaft via the crank assembly due to the pivotal arrangement of the connecting rod and the crank assembly.

Hence, there is an unmet but unresolved need for an apparatus that converts linear reciprocal motion to rotary motion and recovers the portion of wasted energy and uses the recovered energy completely to drive a power shaft.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The apparatus disclosed herein addresses the above stated needs for converting linear reciprocal motion to rotary motion by eliminating and replacing the crank assembly with a fixed moment arm. This is achieved by means of a fixed moment arm orientation between a reciprocating rod and gearing elements in which the combustion force is always perpendicular to the surface on which the combustion force is transmitted. Therefore, the apparatus disclosed herein, with the fixed moment arm orientation between the reciprocating rod and the gearing elements, possesses an inherent and perennial advantage over conventional reciprocating engines. The reciprocating rod of the apparatus disclosed herein transfers all or most part of the combustion force into driving the gearing elements. Furthermore, the apparatus disclosed herein has a larger effective moment arm compared to a conventional reciprocating engine. In operation, the apparatus disclosed herein inherently eliminates the presence of angularity while transmitting combustion force from the reciprocating rod to the gearing elements, and also transmits the combustion force perpendicularly at all times.

The apparatus disclosed herein comprises at least one reciprocating assembly, multiple gear racks, and one or more gearing elements. The reciprocating assembly comprises a reciprocating component and a reciprocating rod capable of linear reciprocal motion in unison. The reciprocating component is a piston. The reciprocating component is rigidly attached to the reciprocating rod along a vertical axis of the reciprocating rod. The reciprocating component is supported by a housing. The reciprocating rod is slidably connected to an idler gear via a guide pin. The reciprocating rod comprises an elongated aperture along the vertical axis of the reciprocating rod. The guide pin is disposed within the elongated aperture to slidably connect the reciprocating rod to the idler gear.

The gear racks are disposed, for example, on opposing sides of the reciprocating rod, for transmitting motion to the gearing elements. Each of the gear racks may be integrated on the reciprocating rod or externally attached to the reciprocating rod. One or more gearing elements are disposed on the opposing sides of the reciprocating rod. The gearing elements are in alternate mesh with the gear racks on the opposing sides of the reciprocating rod to transmit the motion to the idler gear. Each of the gearing elements and each of the gear racks together define a fixed moment arm. The gear racks and the gearing elements are constructed in, for example, a spur gear configuration, a helical gear configuration, or a herringbone gear configuration. The gearing elements mesh with the idler gear rigidly mounted on a power shaft to convert linear reciprocal motion of the reciprocating assembly to rotary motion of the power shaft. A centric axis of the idler gear is collinear to a longitudinal axis of the power shaft. The power shaft is rotatably supported by the housing. In an embodiment, multiple idler gears are rigidly mounted on the power shaft.

Each of the gearing elements comprises a partial gear area on a first section of its width and a full gear area on a second section of its width. The partial gear area on each of the gearing elements is in mesh with one of the gear racks. The full gear area on each of the gearing elements is in mesh with the idler gear. Each of the gearing elements is rigidly mounted on a shaft rotatably supported by the housing.

The apparatus disclosed herein further comprises at least one transfer roller rotatably connected to the reciprocating rod or the idler gear for assisting in alternation of the mesh of the gear racks with each of the gearing elements. The apparatus disclosed herein further comprises a top recess and a bottom recess on the reciprocating rod on a locus of rotation of the transfer roller, to allow passage of the transfer roller through the reciprocating rod. The apparatus disclosed herein further comprises a stabilizing fixture rotatably connected to the power shaft and rigidly attached to the housing to operatively reduce vibrations within the apparatus.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific components and methods disclosed herein.

FIG. 1 exemplarily illustrates a front perspective view of an apparatus for converting linear reciprocal motion to rotary motion.

FIG. 2 exemplarily illustrates a bottom perspective view of the apparatus showing gearing elements and an idler gear.

FIG. 3 exemplarily illustrates an exploded view of the apparatus for converting linear reciprocal motion to rotary motion.

FIG. 4 exemplarily illustrates an exploded view of the apparatus showing a top recess and a bottom recess of a reciprocating rod of the apparatus.

FIG. 5 exemplarily illustrates a front orthogonal view of the apparatus showing a stabilizing fixture.

FIG. 6 exemplarily illustrates a rear orthogonal view of the apparatus showing gearing elements.

FIG. 7 exemplarily illustrates a side sectional view of the apparatus showing a power shaft rotatably supported by a housing.

FIG. 8 exemplarily illustrates a front orthogonal view of a reciprocating assembly with gear racks.

FIG. 9 exemplarily illustrates a side orthogonal view of a reciprocating rod of the reciprocating assembly with gear racks.

FIG. 10 exemplarily illustrates a front orthogonal view of a reciprocating rod of the reciprocating assembly with external gear racks attachable to the reciprocating rod.

FIG. 11 exemplarily illustrates a side orthogonal view of an idler gear of the apparatus.

FIG. 12 exemplarily illustrates a front orthogonal view of the idler gear of the apparatus.

FIG. 13 exemplarily illustrates a side orthogonal view of a power shaft of the apparatus.

FIG. 14 exemplarily illustrates a front orthogonal view of the power shaft of the apparatus.

FIG. 15 exemplarily illustrates a side orthogonal view of a gearing element of the apparatus.

FIG. 16 exemplarily illustrates a front orthogonal view of the gearing element of the apparatus.

FIG. 17 exemplarily illustrates a side orthogonal view of a shaft of the gearing element.

FIG. 18 exemplarily illustrates a front orthogonal view of the shaft of the gearing element.

FIGS. 19A-19C exemplarily illustrate rear sectional views of the apparatus in operation.

FIG. 20 exemplarily illustrates an orthogonal view of the apparatus showing the fixed moment arm achieved.

FIGS. 21A-21C exemplarily illustrate orthogonal views of the apparatus showing variations in position of an additional power shaft.

FIG. 22 exemplarily illustrates an orthogonal view of the apparatus in a multi-cylinder environment.

FIG. 23 exemplarily illustrates a side orthogonal view of the apparatus in a multi-cylinder environment.

FIG. 24 exemplarily illustrates an orthogonal view of the apparatus showing the stabilizing fixture in a multi-cylinder environment.

FIG. 25 exemplarily illustrates a side orthogonal view of the apparatus showing the stabilizing fixture in a multi-cylinder environment.

FIG. 26 exemplarily illustrates a method of converting linear reciprocal motion to rotary motion.

### DETAILED DESCRIPTION OF THE INVENTION

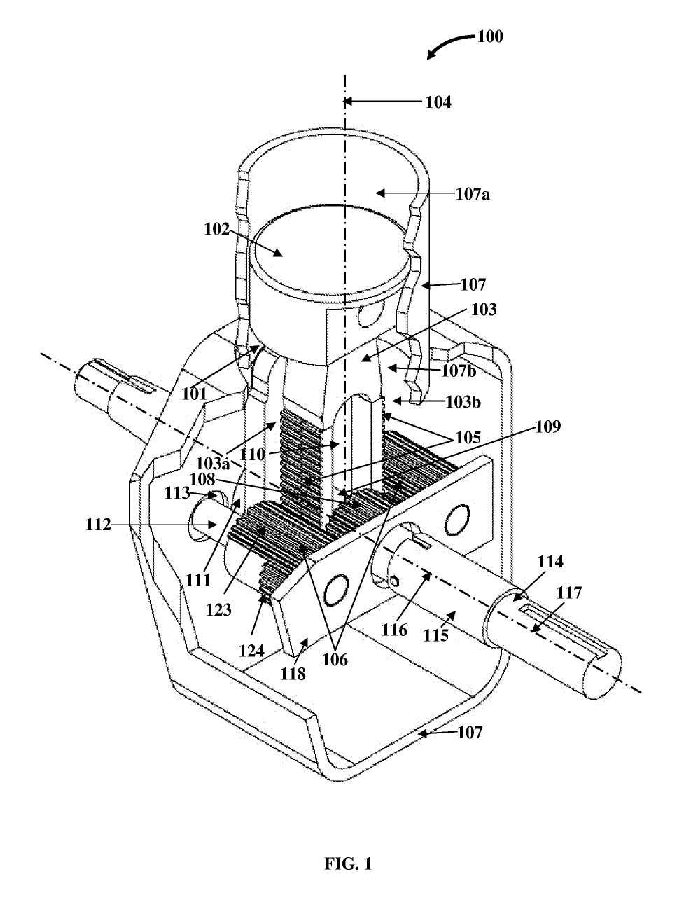

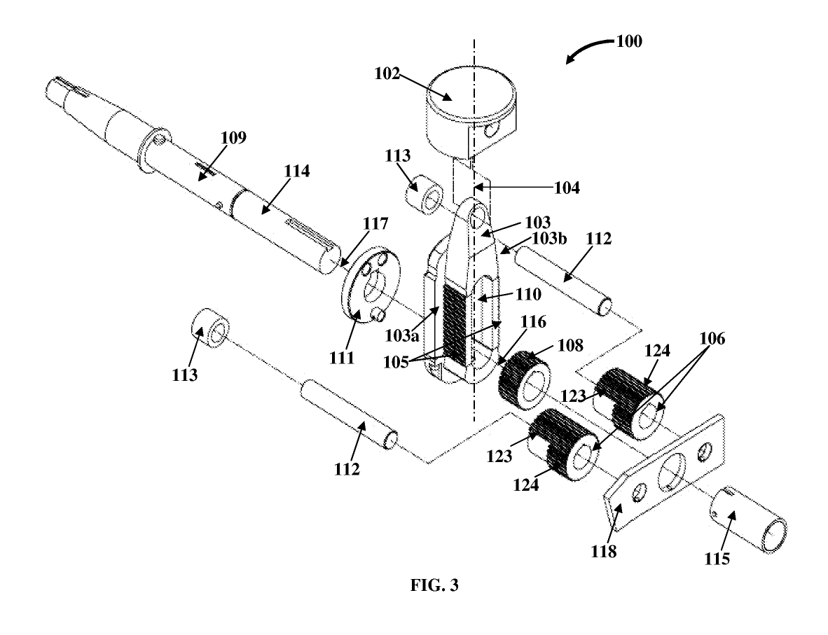

FIG. 1 exemplarily illustrates a front perspective view of an apparatus 100 for converting linear reciprocal motion to rotary motion. The apparatus 100 disclosed herein comprises at least one reciprocating assembly 101, gear racks 105, and gearing elements 106. The reciprocating assembly 101 comprises a reciprocating component 102 and a reciprocating rod 103 capable of linear reciprocal motion in unison. The reciprocating component 102 is rigidly attached to the reciprocating rod 103 along a vertical axis 104 of the reciprocating rod 103. The reciprocating component 102 is supported by a housing 107. The reciprocating component 102 is a piston and is herein referred to as a “piston” 102. The reciprocating rod 103 is slidably connected to an idler gear 108 via a guide pin 109 as exemplarily illustrated in FIG. 3. The gear racks 105 disposed on opposing sides 103a and 103b of the reciprocating rod 103 transmit motion to the gearing elements 106. The reciprocating rod 103 comprises an elongated aperture 110 along the vertical axis 104 of the reciprocating rod 103. The guide pin 109 is disposed within the elongated aperture 110 to slidably connect the reciprocating rod 103 to the idler gear 108.

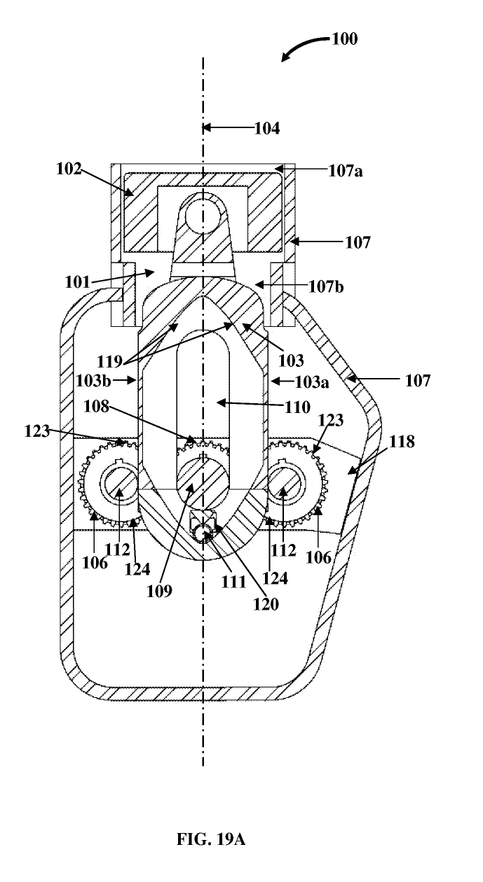

The gearing elements 106 are disposed on opposing sides 103a and 103b of the reciprocating rod 103. Each of the gearing elements 106 is rigidly mounted on a shaft 112 rotatably supported by the housing 107 via a collar bush 113 rigidly attached to the housing 107. Each of the gearing elements 106 comprises a partial gear area 123 and a full gear area 124 as disclosed in the detailed description of FIG. 15. The gearing elements 106 are in alternate mesh with the gear racks 105 on opposing sides 103a and 103b of the reciprocating rod 103 to transmit the motion to the idler gear 108. That is, during operation of the apparatus 100 disclosed herein, the partial gear area 123 of one gearing element 106 on one opposing side 103a of the reciprocating rod 103 is in mesh with the gear rack 105 on that opposing side 103a of the reciprocating rod 103, while the partial gear area 123 on the opposing gearing element 106 on the other opposing side 103b is not in mesh with the gear rack 105 on the other opposing side 103b of the reciprocating rod 103. As used herein, “alternate mesh” refers to an alternation in meshing of the partial gear areas 123 of the opposing gearing elements 106 with the gear racks 105 on the opposing sides 103a and 103b of the reciprocating rod 103, while the full gear areas 124 of the opposing gearing elements 106 are constantly in mesh with the idler gear 108.

The gear racks 105 and the gearing elements 106 are constructed in, for example, a spur gear configuration, a helical gear configuration, or a herringbone gear configuration. The gearing elements 106 mesh with the idler gear 108 rigidly mounted on a power shaft 114 to convert the linear reciprocal motion of the reciprocating assembly 101 to rotary motion of the power shaft 114. A centric axis 116 of the idler gear 108 is collinear to a longitudinal axis 117 of the power shaft 114. The power shaft 114 is rotatably supported by the housing 107 via a collar bush 115 rigidly attached to the housing 107.

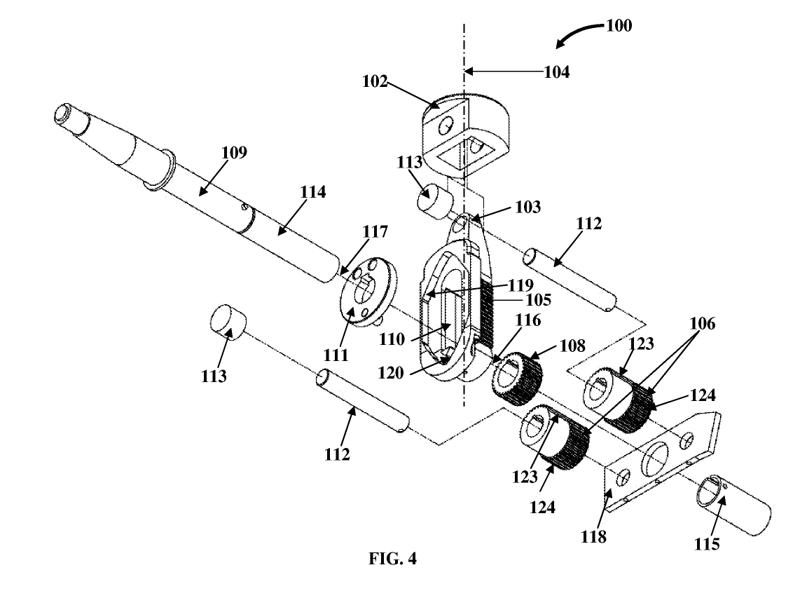

The apparatus 100 disclosed herein further comprises a transfer roller 111 rotatably connected to the reciprocating rod 103. The transfer roller 111 assists in alternation of the mesh of the gear racks 105 with each of the gearing elements 106. In an embodiment, the reciprocating rod 103 comprises a top recess 119 and a bottom recess 120, as exemplarily illustrated in FIG. 4, on a locus of rotation of the transfer roller 111, to allow passage of the transfer roller 111 through the reciprocating rod 103.

The apparatus 100 further comprises a stabilizing fixture 118 rigidly attached to the housing 107 to operatively reduce vibrations within the apparatus 100. The power shaft 114 and the shafts 112 of the apparatus 100 are rotatably connected to the stabilizing fixture 118.

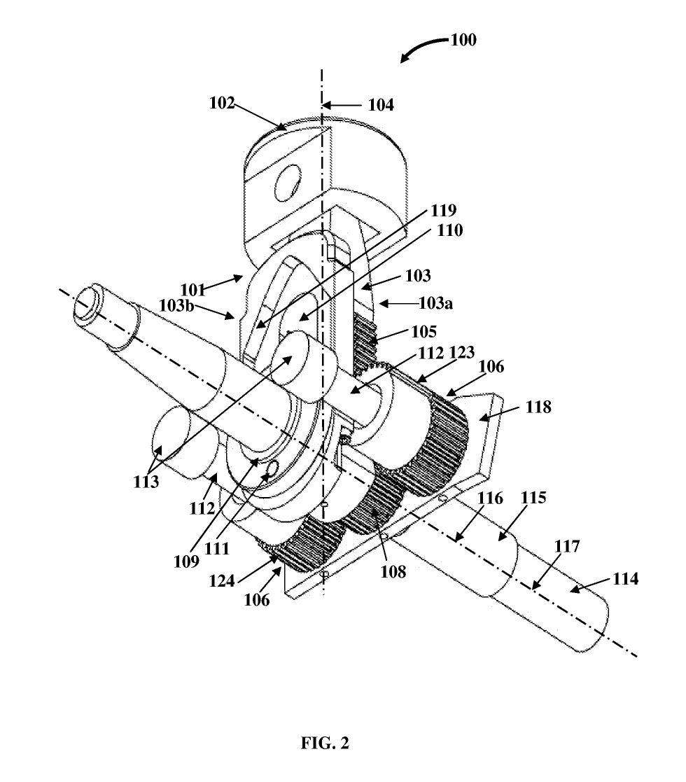

FIG. 2 exemplarily illustrates a bottom perspective view of the apparatus 100 showing the gearing elements 106 and the idler gear 108. The centric axis 116 of the idler gear 108 is collinear to the longitudinal axis 117 of the power shaft 114. The idler gear 108 is rigidly attached to the power shaft 114. The reciprocating rod 103 is slidably connected to the idler gear 108 via the guide pin 109 as disclosed in the detailed description of FIG. 1.

FIG. 3 exemplarily illustrates an exploded view of the apparatus 100 for converting linear reciprocal motion to rotary motion. The piston 102 is rigidly attached to the reciprocating rod 103 along the vertical axis 104 of the reciprocating rod 103. The reciprocating rod 103 comprises the elongated aperture 110 along the vertical axis 104 through which the guide pin 109 is inserted to slidably connect the reciprocating rod 103 to the idler gear 108. Furthermore, the centric axis 116 of the idler gear 108 is collinear to the longitudinal axis 117 of the power shaft 114.

FIG. 4 exemplarily illustrates an exploded view of the apparatus 100 showing a top recess 119 and a bottom recess 120 of the reciprocating rod 103 of the apparatus 100. The top recess 119 and the bottom recess 120 is provided on the reciprocating rod 103 on a locus of rotation of the transfer roller 111, to allow passage of the transfer roller 111 through the reciprocating rod 103 as disclosed in the detailed description of FIG. 1.

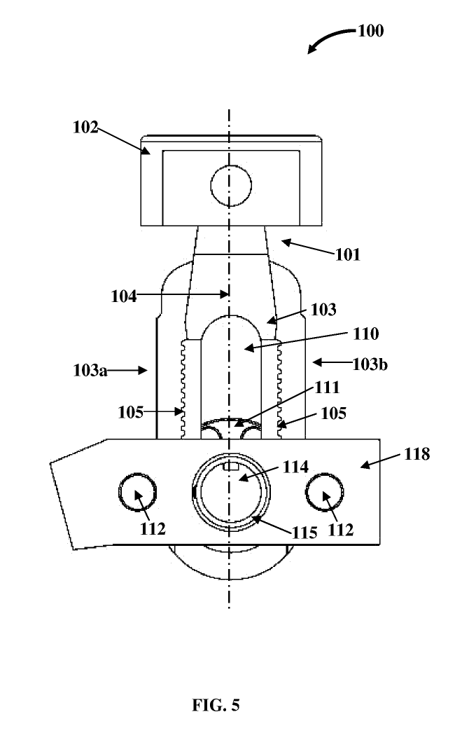

FIG. 5 exemplarily illustrates a front orthogonal view of the apparatus 100 showing a stabilizing fixture 118. The stabilizing fixture 118 is rigidly attached to the housing 107 of the apparatus 100 as disclosed in the detailed description of FIG. 1. The stabilizing fixture 118 is rigidly attached to the housing 107 by, for example, riveting, bolting, welding, etc. In an embodiment, the stabilizing fixture 118 is pre-cast or integrated as a part of the housing 107. The stabilizing fixture 118 is rotatably connected to the power shaft 114. Since the power shaft 114 and the reciprocating assembly 101 exhibit vibrations, the stabilizing fixture 118 transmits the vibrations to the housing 107 thereby reducing the vibrations of the power shaft 114 and the reciprocating assembly 101 within the apparatus 100.

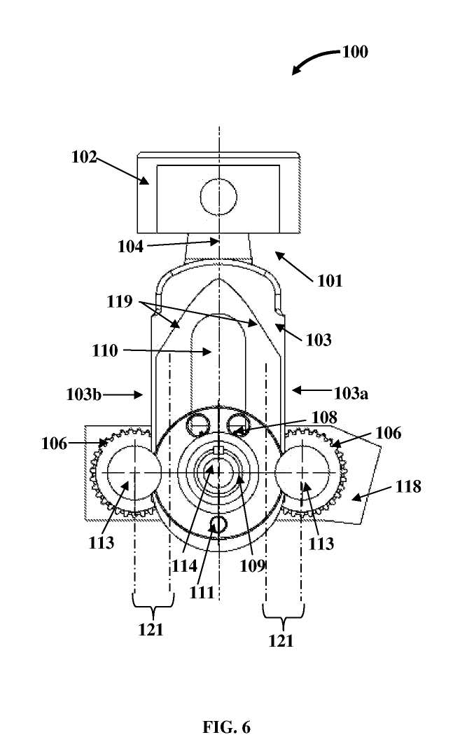

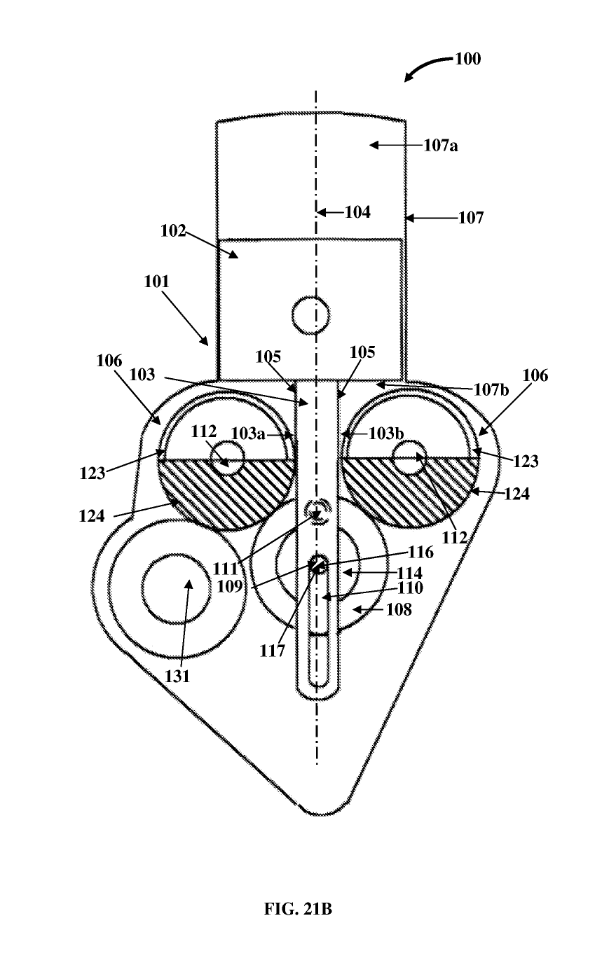

FIG. 6 exemplarily illustrates a rear orthogonal view of the apparatus 100 showing the gearing elements 106. The gearing elements 106 are disposed on opposing sides 103a and 103b of the reciprocating rod 103. The gearing elements 106 are in alternate mesh with the gear racks 105 on opposing sides 103a and 103b of the reciprocating rod 103 to transmit the motion to the idler gear 108 as disclosed in the detailed description of FIG. 1. Each of the gearing elements 106 and each of the gear racks 105 together define a fixed moment arm 121 as disclosed in the detailed description of FIG. 20.

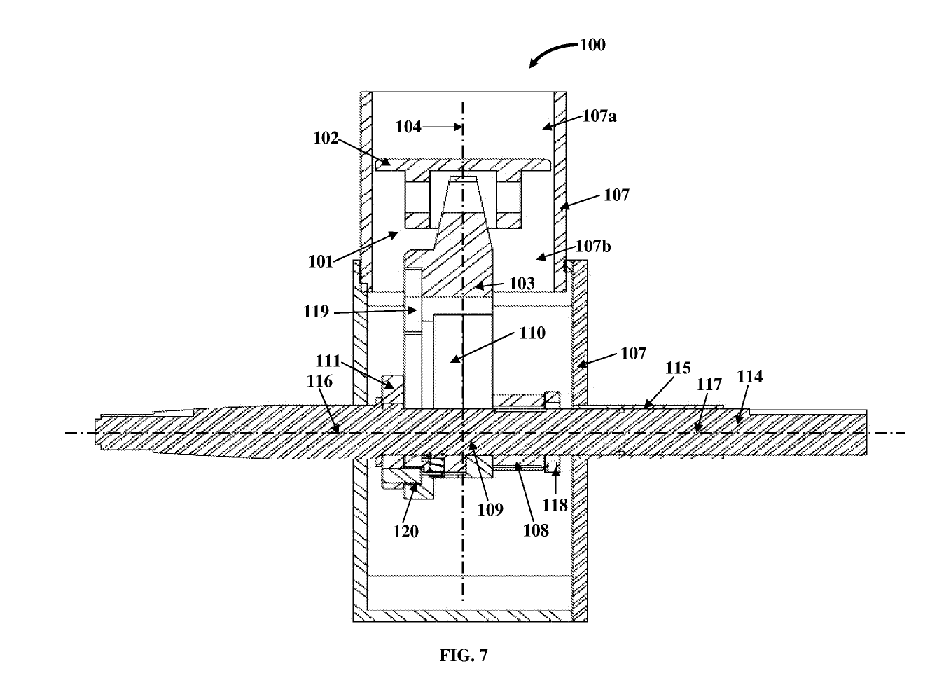

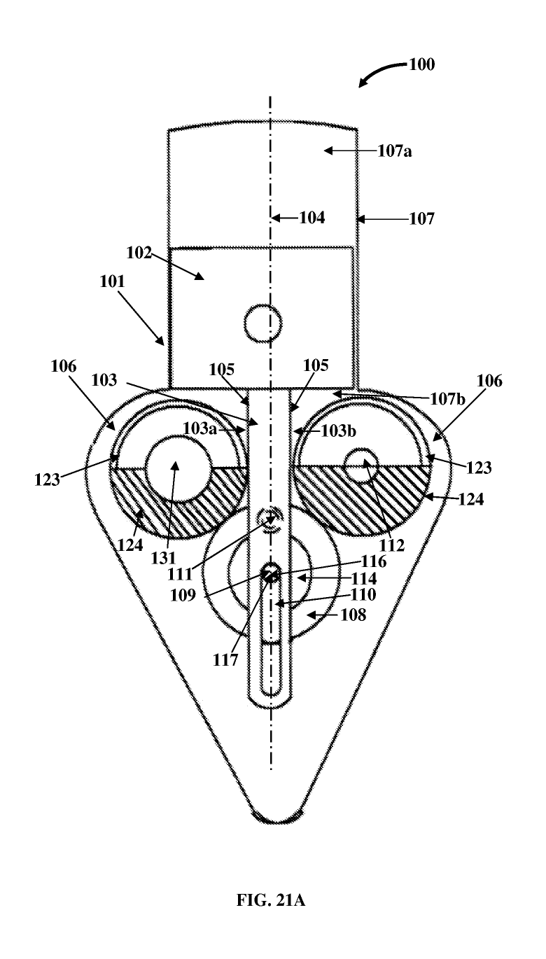

FIG. 7 exemplarily illustrates a side sectional view of the apparatus 100 showing a power shaft 114 rotatably supported by a housing 107 via a collar bush 115. The reciprocating rod 103 comprises the top recess 119 and the bottom recess 120 on the locus of rotation of the transfer roller 111, to allow passage of the transfer roller 111 through the reciprocating rod 103 during operation of the apparatus 100. The top recess 119 is in operation when the piston 102 is at a bottom dead center (BDC) 107b of the housing 107 as exemplarily illustrated in FIG. 19C. The top recess 119 is disposed on the reciprocating rod 103 to allow passage of the transfer roller 111 through the reciprocating rod 103 when the piston 102 is at the BDC 107b of the housing 107. The top recess 119 on the reciprocating rod 103 facilitates soft engagement of the transfer roller 111 with the reciprocating rod 103. The bottom recess 120 on the reciprocating rod 103 facilitates soft engagement of the transfer roller 111 with the reciprocating rod 103. The bottom recess 120 is in operation when the piston 102 is at a top dead center (TDC) 107a of the housing 107 as exemplarily illustrated in FIG. 19A. The bottom recess 120 is disposed on the reciprocating rod 103 to allow passage of the transfer roller 111 through the reciprocating rod 103 when the piston 102 is at the TDC 107a of the housing 107. The top recess 119 and the bottom recess 120 provide a curvature to ensure smooth transition of the reciprocating rod 103 within the apparatus 100 during operation. In an embodiment as exemplarily illustrated in FIG. 20, an up exit relief 130 and a down exit relief 129 are disposed along the gear racks 105 to provide for an extra space between the gear racks 105 and the gearing elements 106 as the gearing elements 106 come in alternate mesh with the gear racks 105 on the opposing sides 103a and 103b of the reciprocating rod 103.

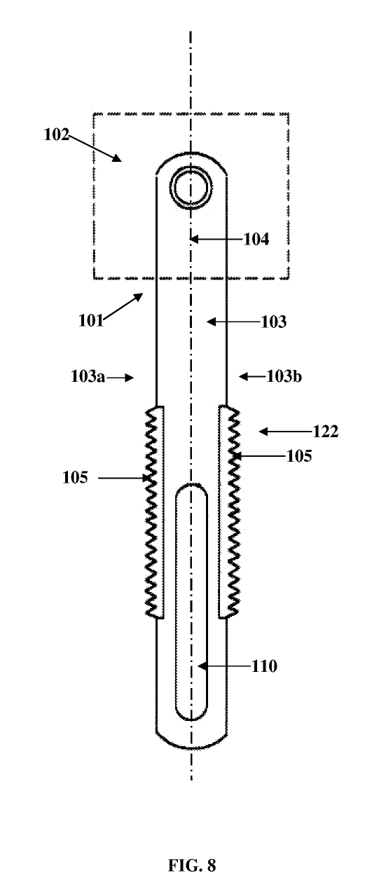

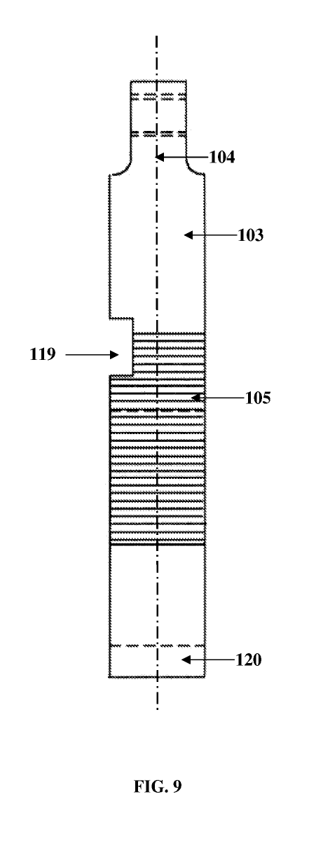

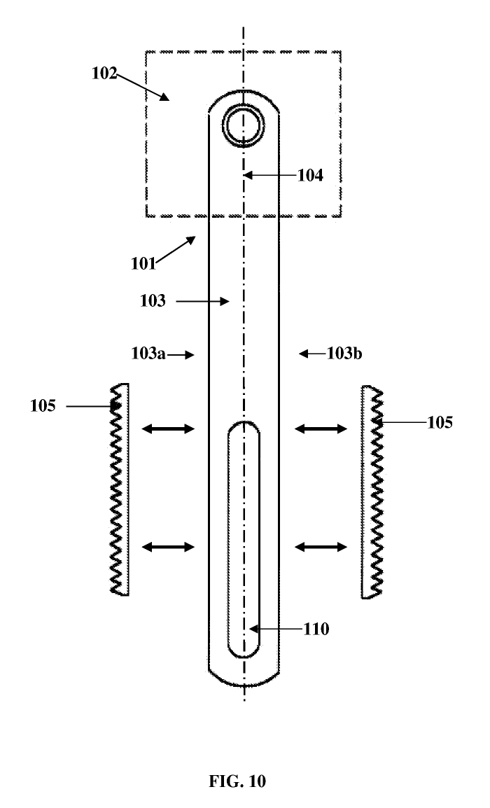

FIGS. 8-10 exemplarily illustrate orthogonal views of the reciprocating assembly 101 with the gear racks 105 of the apparatus 100. In an embodiment as exemplarily illustrated in FIG. 8, each of the gear racks 105 is integrated on the reciprocating rod 103. For example, a racked reciprocating rod 122 is provided as a combination of the reciprocating rod 103 and the gear racks 105. FIG. 9 also illustrates the top recess 119 and the bottom recess 120 of the reciprocating rod 103. The top recess 119 and the bottom recess 120 allow the transfer roller 111 to pass through the reciprocating rod 103. In another embodiment as exemplarily illustrated in FIG. 10, each of the gear racks 105 is externally attached to the reciprocating rod 103. In this embodiment, the gear racks 105 and the reciprocating rod 103 are separate entities, wherein the gear racks 105 are externally attached to the reciprocating rod 103.

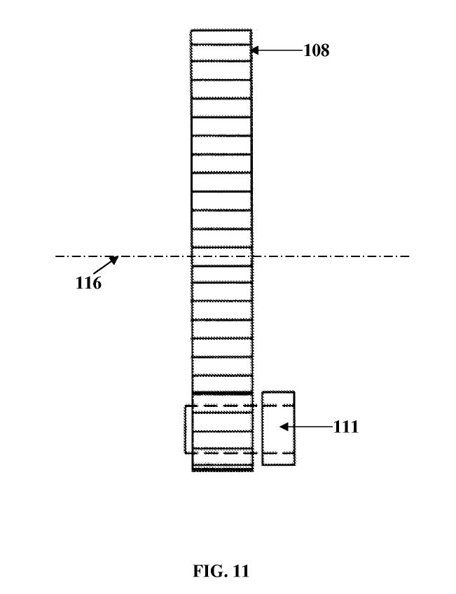

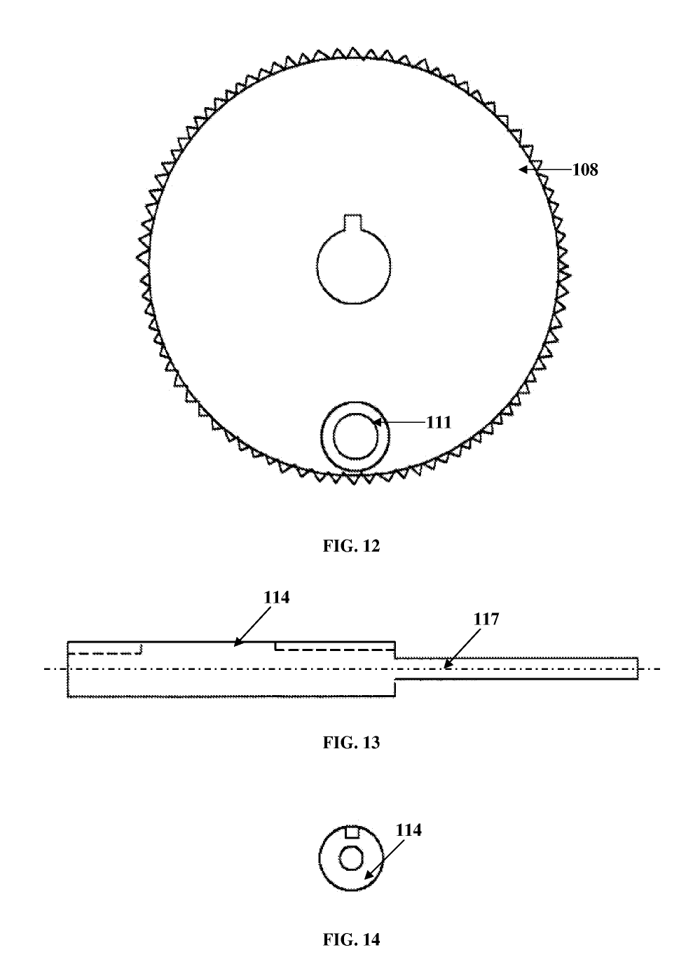

FIGS. 11-12 exemplarily illustrate a side orthogonal view and a front orthogonal view of the idler gear 108 of the apparatus 100 respectively. The idler gear 108 is rigidly mounted on the power shaft 114 as disclosed in the detailed description of FIG. 1. The gearing elements 106 synchronously mesh with the idler gear 108 to convert linear reciprocal motion of the reciprocating assembly 101 to rotary motion of the power shaft 114. In an embodiment, the idler gear 108 is rotatably attached with at least one transfer roller 111 to alternate the mesh of the gear racks 105 on the reciprocating rod 103 with each of the gearing elements 106 that mesh with the idler gear 108. The centric axis 116 of the idler gear 108 is collinear to the longitudinal axis 117 of the power shaft 114 as exemplarily illustrated in FIGS. 3-4.

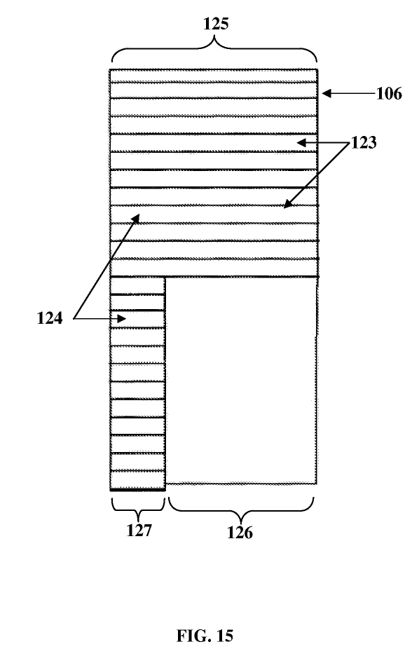

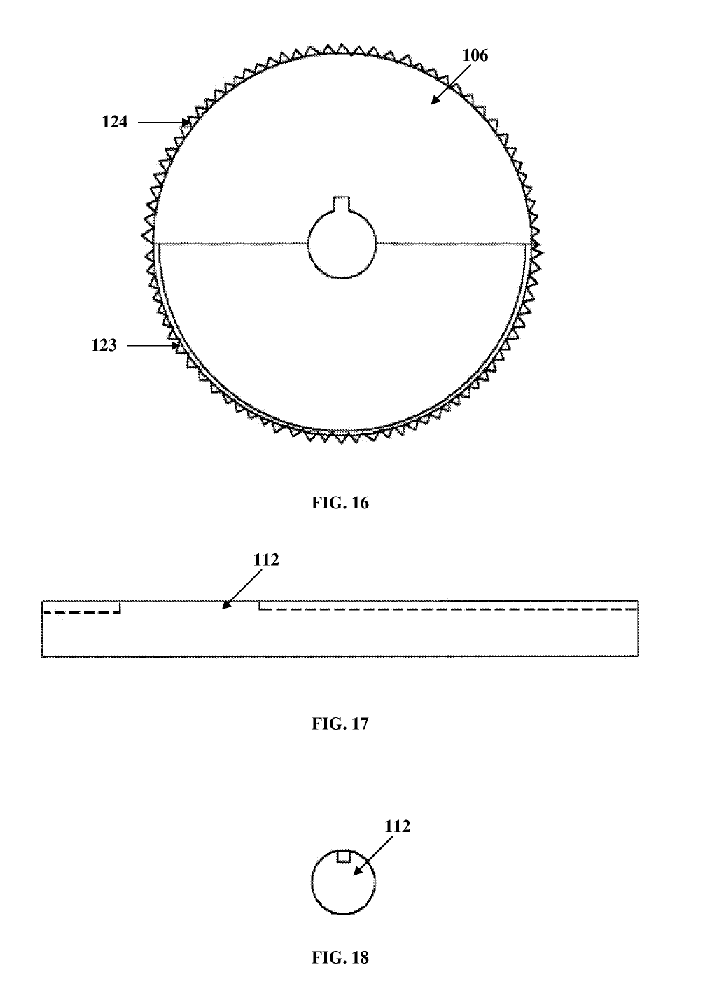

FIGS. 13-14 exemplarily illustrate a side orthogonal view and a front orthogonal view of the power shaft 114 of the apparatus 100 respectively. The power shaft 114 is rotatably supported by the housing 107 as exemplarily illustrated FIG. 1. The idler gear 108 is rigidly mounted on the power shaft 114. The centric axis 116 of the idler gear 108 is collinear to the longitudinal axis 117 of the power shaft 114. The idler gear 108 may be secured to the power shaft 114 by, for example, a key, a thermal weld, etc.

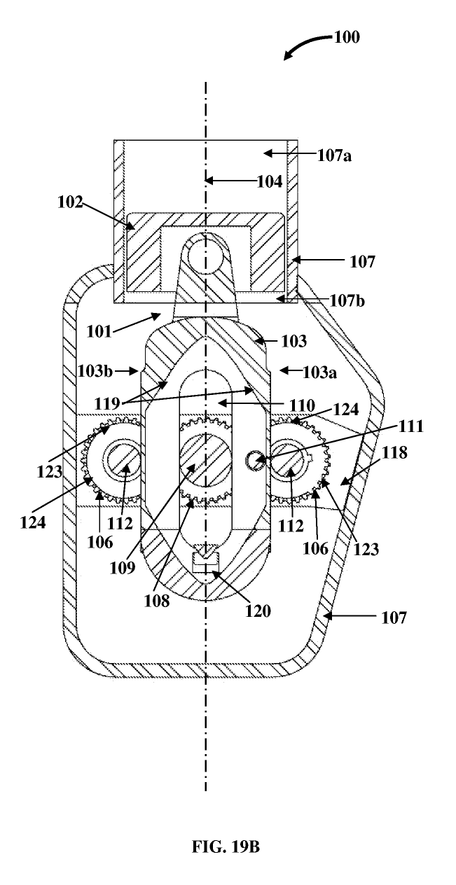

FIGS. 15-16 exemplarily illustrate a side orthogonal view and a front orthogonal view of the gearing element 106 of the apparatus 100. Each of the gearing elements 106 is rigidly mounted on the shaft 112 as exemplarily illustrated in FIGS. 1-2. Each of the gearing elements 106 comprises a partial gear area 123 on a first section 126 of its width 125 and a full gear area 124 on a second section 127 of its width 125. The partial gear area 123 on each of the gearing elements 106 is in mesh with one of the gear racks 105 on the reciprocating rod 103 and the full gear area 124 on each of the gearing elements 106 is in mesh with the idler gear 108 as exemplarily illustrated in FIGS. 1-2.

For purposes of illustration, the detailed description refers to a partial gear area 123 and a full gear area 124 defined on the first section 126 and the second section 127 of the width 125 of the gearing element 106 respectively; however, the scope of the gearing element 106 disclosed herein is not limited to a partial gear area 123 on the first section 126 and a full gear area 124 on the second section 127 of the width 125 of the gearing element 106 but may be extended to include variable gear areas on different sections of the gearing element 106. For example, alternate approximate quadrant sections of partial gear area 123 may be defined on the first section 126 of the width 125 of the gearing element 106 and a full gear area 124 may be defined on the second section 127 of the width 125 of the gearing element 106.

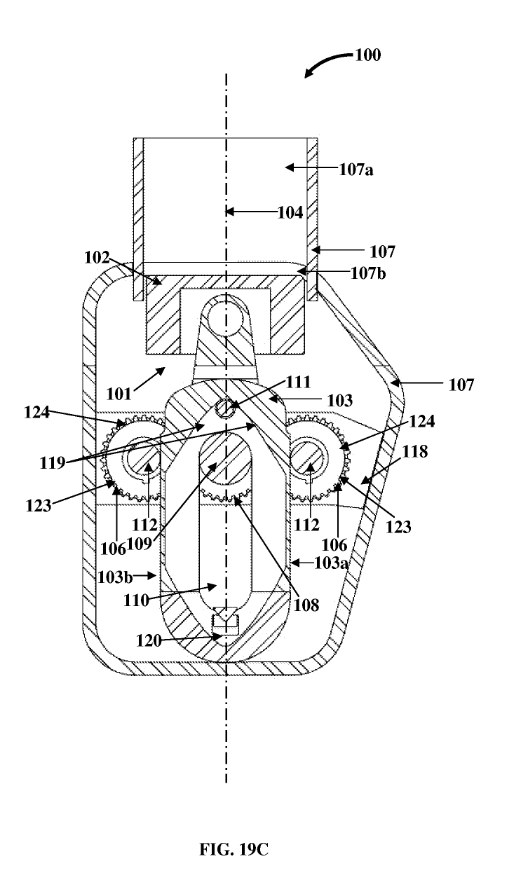

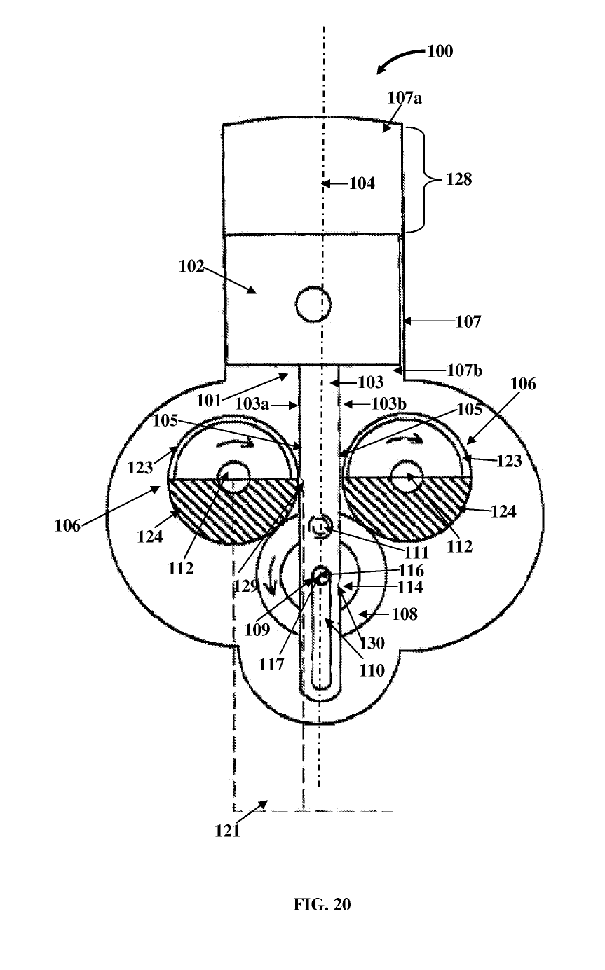

FIGS. 17-18 exemplarily illustrate a side orthogonal view and a front orthogonal view of a shaft 112 of each of the gearing elements 106 respectively. Each of the gearing elements 106 is rigidly mounted on the shaft 112 as disclosed in the detailed description of FIG. 1. Each of the gearing elements 106 is rigidly mounted on the shaft 112 by, for example, a key, a thermal weld, etc.

FIGS. 19A-19C exemplarily illustrate rear sectional views of the apparatus 100 in operation. The full gear area 124 on each of the gearing elements 106 is constantly in mesh with the idler gear 108 during each instant of operation of the apparatus 100.

As exemplarily illustrated in FIG. 19A, the piston 102 is at the TDC 107a of the housing 107 while the transfer roller 111 provided on the idler gear 108 is within the bottom recess 120 of the reciprocating rod 103. During this instant of operation, the partial gear area 123 of one of the gearing elements 106 on one of the opposing sides 103b approaches a mesh with the gear rack 105 on the reciprocating rod 103 while the partial gear area 123 of the other one of the gearing elements 106 on the other opposing side 103a exits a mesh with the gear rack 105 on the reciprocating rod 103.

As exemplarily illustrated in FIG. 19B, the piston 102 is approximately mid-way between the TDC 107a and the BDC 107b of the housing 107 while the transfer roller 111 provided on the idler gear 108 is between the top recess 119 and the bottom recess 120 of the reciprocating rod 103. During this instant of operation, the partial gear area 123 of one of the gearing elements 106 is in mesh with the gear rack 105 on one of the opposing sides 103b of the reciprocating rod 103 while the partial gear area 123 of another of the gearing elements 106 is not in mesh with the gear rack 105 on the opposing side 103a of the reciprocating rod 103.

As exemplarily illustrated in FIG. 19C, the piston 102 is at the BDC 107b of the housing 107 while the transfer roller 111 provided on the idler gear 108 is within the top recess 119 of the reciprocating rod 103. During this instant of operation, the partial gear area 123 of one of the gearing elements 106 on the opposing side 103a approaches a mesh with the gear rack 105 while the partial gear area 123 of another one of the gearing elements 106 exits a mesh with the gear rack 105 on the opposing side 103b of the reciprocating rod 103.

Consider the operation of the apparatus 100 disclosed herein. A mixture of fuel and air is ignited at the TDC 107a of the housing 107. The piston 102 exhibits a linear reciprocal motion. The reciprocating rod 103 which is rigidly attached to the piston 102 consequently exhibits the linear reciprocal motion along with the piston 102. The gear racks 105 rigidly attached on the opposing sides 103a and 103b of the reciprocating rod 103 transfer the linear reciprocal motion to the gearing elements 106. The gearing elements 106 convert the linear reciprocal motion into a rotary motion and transfer this rotary motion to the idler gear 108. The transfer roller 111 on the idler gear 108 alternates the transmission of the linear reciprocal motion from the gear racks 105 to the gearing elements 106, that is, when the piston 102 moves from the TDC 107a of the housing 107 to the BDC 107b of the housing 107, the linear reciprocal motion of the reciprocating rod 103 is transferred from the gear racks 105 on one of the opposing sides 103a of the reciprocating rod 103 to the gearing elements 106 disposed on the associated one of the opposing sides 103a of the reciprocating rod 103, and when the piston 102 moves from the BDC 107b to the TDC 107a of the housing 107, the linear reciprocal motion of the reciprocating rod 103 is transferred from the gear racks 105 on the other opposing side 103b of the reciprocating rod 103 to the gearing elements 106 disposed on the other opposing side 103b of the reciprocating rod 103. In this manner, the linear reciprocal motion of the reciprocating rod 103 is transmitted to the gearing elements 106 on opposing sides 103a and 103b of the reciprocating rod 103 alternately and the subsequent rotary motion of each of the gearing elements 106 is transmitted to the idler gear 108 alternately.

FIG. 20 exemplarily illustrates an orthogonal view of the apparatus 100 showing the fixed moment arm 121 achieved. The apparatus 100 disclosed herein comprises a fixed stroke length 128 of the piston 102, for example, a two inch stroke length, for which a fixed moment arm 121 exists, for example, a 0.633 inch moment arm. In the apparatus 100 disclosed herein, a mixture of fuel and air is ignited in the housing 107 and a combustion force is produced as a result of the ignition of the mixture of fuel and air. This combustion force is transmitted, with its maximum magnitude, to the power shaft 114, thereby increasing efficiency by approximately 93 percent for a two inch stroke length as disclosed below.

The apparatus 100 disclosed herein using a two inch stroke length develops a fixed moment arm 121. For a 2″ stroke length, the circumferences of the gearing elements 106 and the idler gear 108 must be a working 4″, thereby creating a working diameter of 1.27″ for each of the gearing elements 106. By dividing the working diameter by two, a 0.633″ fixed moment arm 121 is obtained. This fixed moment arm 121 yields approximately 93% increase in power output and torque of the apparatus 100 by evaluating the percentage change in moment arm length, 0.3″, over the original moment arm length 0.33″ of a conventional reciprocating engine.

Hence, the apparatus 100 having a two inch stroke length is approximately 93% more efficient compared to the conventional reciprocating engine having the same stroke length. Alternatively, the apparatus 100 can be reduced in size by approximately 93% when compared to the 2″ stroke length conventional reciprocating engine for the same power output. The apparatus 100 disclosed herein is used in, for example, aircrafts, trains, buses, trucks, cars, motorcycles, lawnmowers, pumps, motors, generators, other engine driven devices, etc.

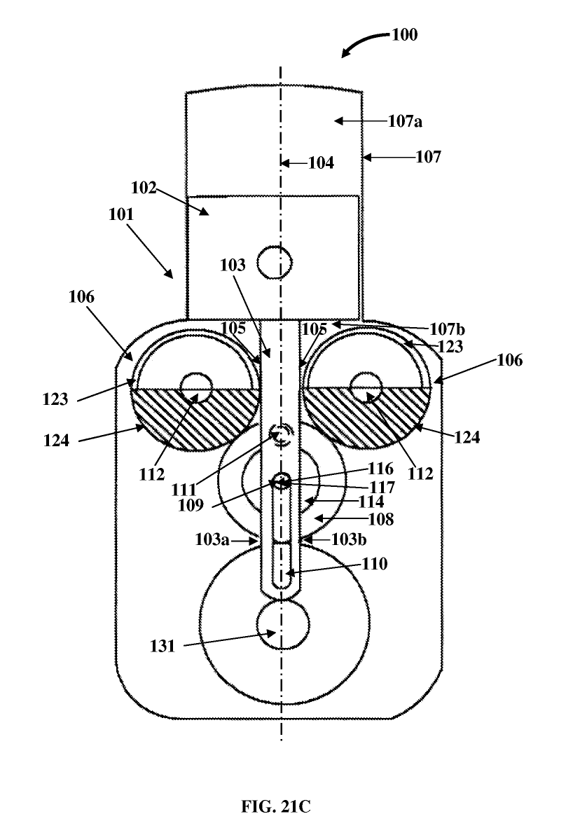

FIGS. 21A-21C exemplarily illustrate orthogonal views of the apparatus 100 showing variations in position of an additional power shaft 131. In an embodiment, in addition to the power shaft 114, another power shaft 131 is provided to adjustably vary the origin of output power in the apparatus 100. In another embodiment, the shaft 112 of each of the gearing elements 106 may also be used to draw output power generated by the apparatus 100. The power shaft 131 is disposed proximal to the idler gear 108. The power shaft 131 is positioned, for example, above, below, or alongside the idler gear 108. The variation in position of the power shaft 131 enables adjustable variation of the origin of output power. For example, in FIG. 21A, the power shaft 131 is positioned above the idler gear 108 and is rigidly connected to the gearing element 106 which is in mesh with the idler gear 108. In another example as illustrated in FIG. 21B, the power shaft 131 is positioned alongside the idler gear 108. In another example as illustrated in FIG. 21C, the power shaft 131 is positioned below the idler gear 108. The origin of the power output is thereby adjustably varied to suit a specific requirement of the apparatus 100.

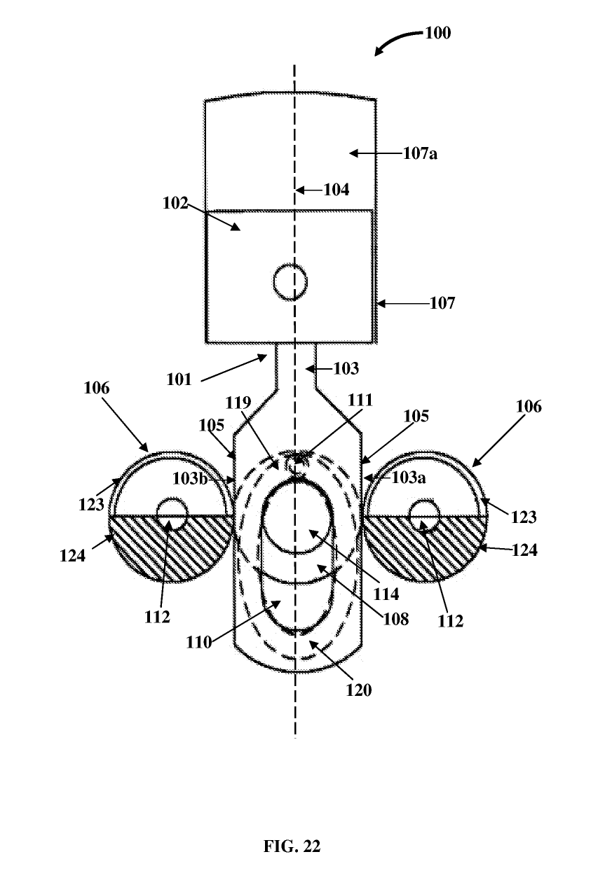

FIG. 22 exemplarily illustrates an orthogonal view of the apparatus 100 in a multi-cylinder environment. The apparatus 100 disclosed herein is adapted for a multi-cylinder environment, where more than one piston 102 and reciprocating rod 103 arrangement exists. In the multi-cylinder environment, multiple reciprocating assemblies 101 are rotatably secured to the power shaft 114 via multiple reciprocating rods 103. The power shaft 114 in a multi-cylinder application is substantially elongated to enable rotatable connection to more than one reciprocating assembly 101.

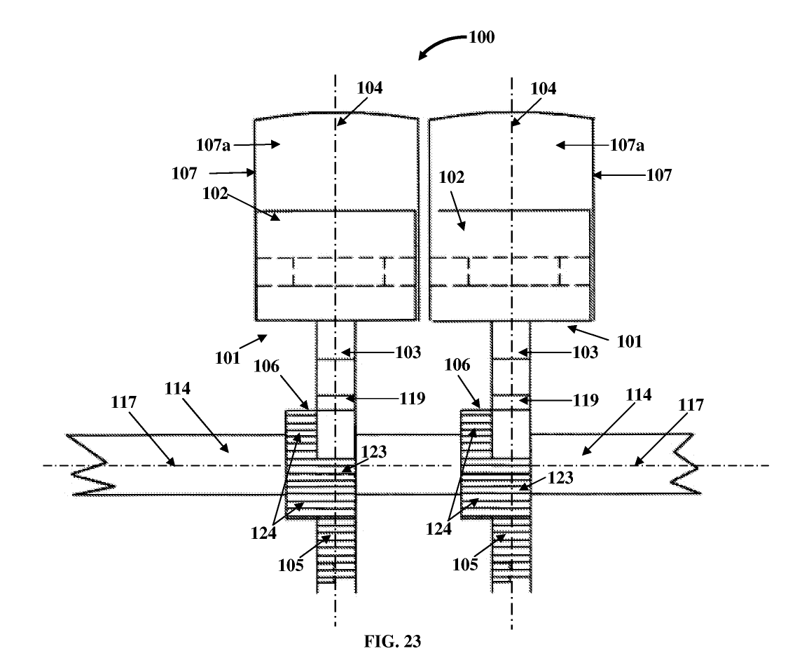

FIG. 23 exemplarily illustrates a side orthogonal view of the apparatus 100 in a multi-cylinder environment. Multiple idler gears 108 are rigidly mounted on the power shaft 114 of the apparatus 100 to adapt to the multi-cylinder environment. The power shaft 114 in a multi-cylinder application enables easy drawing of power from a single point of the apparatus 100. In another embodiment, multiple power shafts 114 are provided, for example, above, below, or alongside the idler gear 108 if the power needs to be drawn from multiple points of the apparatus 100 as disclosed in the detailed description of FIGS. 21A-21C.

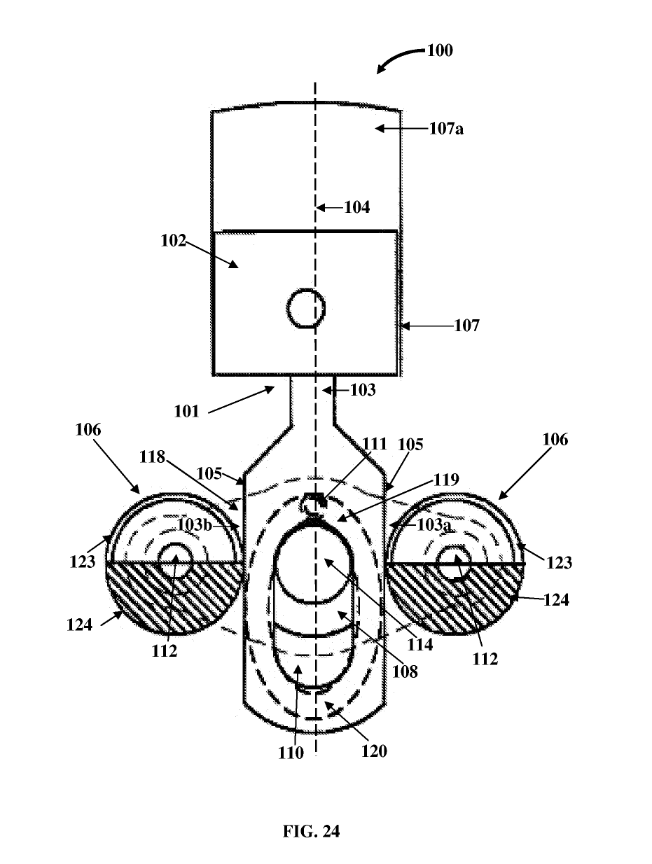

FIG. 24 exemplarily illustrates an orthogonal view of the apparatus 100 showing a stabilizing fixture 118 in the multi-cylinder environment, wherein more than one piston 102 and reciprocating rod 103 arrangement exists. The stabilizing fixture 118 is disposed on the power shaft 114 to provide tolerance to the piston 102 and the shafts 112. For example, in a multi-cylinder environment, the stabilizing fixture 118 is provided to reduce vibrations of the piston 102.

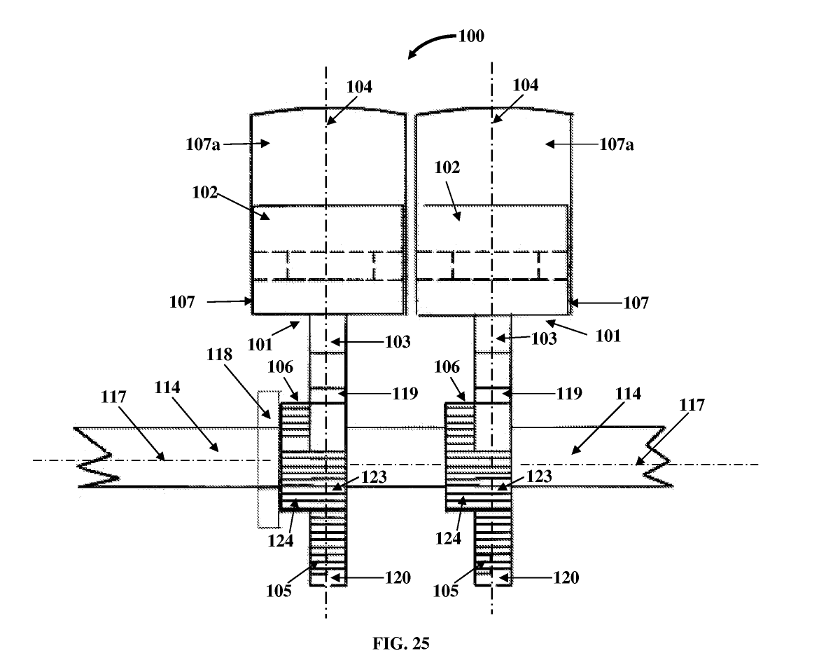

FIG. 25 exemplarily illustrates a side orthogonal view of the apparatus 100 showing the stabilizing fixture 118 in the multi-cylinder environment. The stabilizing fixture 118 is rotatably connected to the power shaft 114 to provide tolerance to the power shaft 114.

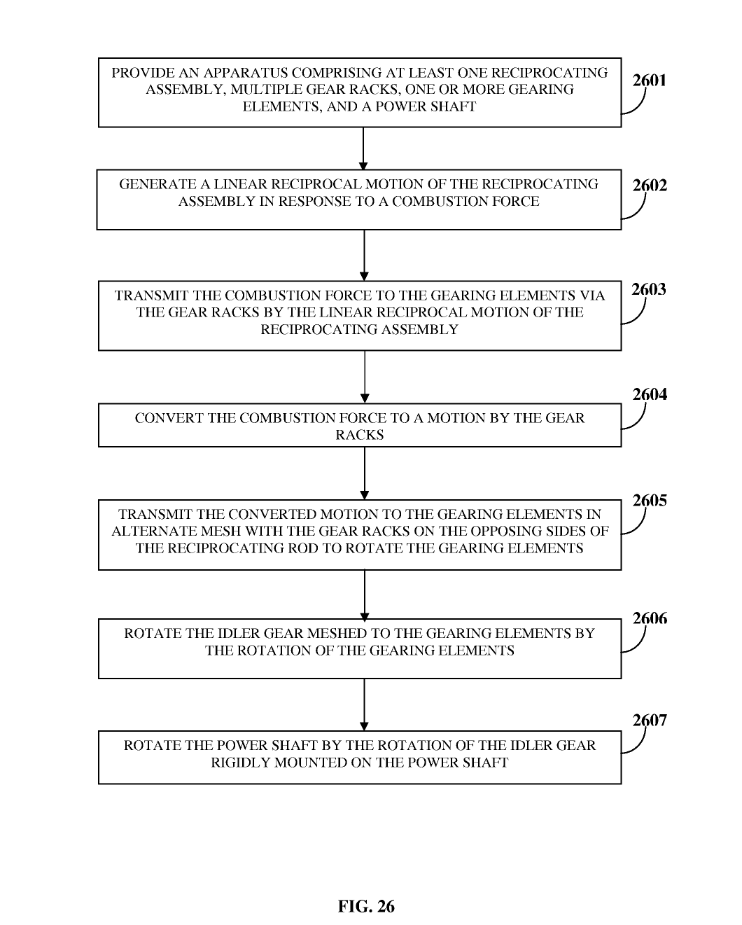

FIG. 26 exemplarily illustrates a method of converting linear reciprocal motion to rotary motion. An apparatus 100 comprising at least one reciprocating assembly 101, multiple gear racks 105, one or more gearing elements 106, and a power shaft 114 as illustrated and disclosed in the detailed description of FIGS. 1-25, is provided 2601. The gearing elements 106 are disposed in a predetermined configuration to enable alternate meshing of the gearing elements 106 with the gear racks 105 on the opposing sides 103a and 103b of the reciprocating rod 103 and to enable constant meshing of the gearing elements 106 with the idler gear 108 during operation of the apparatus 100. For example, the gearing elements 106 are arranged in a configuration such that the partial gear area 123 of one gearing element 106 is in mesh with the gear rack 105 on one of the opposing sides 103a of the reciprocating rod 103 while the partial gear area 123 of an opposing gearing element 106 is not in mesh with the gear rack 105 disposed on the other opposing side 103b of the reciprocating rod 103. Therefore, the partial gear area 123 of each of the gearing elements 106 on opposing sides 103a and 103b is in alternate mesh with the gear racks 105 on the reciprocating rod 103.

A linear reciprocal motion of the reciprocating assembly 101 is generated 2602 in response to a combustion force. The combustion force is transmitted 2603 to the gearing elements 106 via the gear racks 105 by the linear reciprocal motion of the reciprocating assembly 101. The gear racks 105 convert 2604 the combustion force to a motion. The converted motion is transmitted 2605 to the gearing elements 106 in alternate mesh with the gear racks 105 on opposing sides 103a and 103b of the reciprocating rod 103 to rotate the gearing elements 106. The meshing of the gear racks 105 with each of the gearing elements 106 is alternated using a transfer roller 111 rotatably connected to the reciprocating rod 103 or the idler gear 108. The idler gear 108 meshed to the gearing elements 106 is rotated 2606 by the rotation of the gearing elements 106. The power shaft 114 is rotated 2607 by the rotation of the idler gear 108 rigidly mounted on the power shaft 114. The rotary motion is thereby generated at the power shaft 114 of the apparatus 100. The vibrations within the apparatus 100 are operatively reduced using the stabilizing fixture 118 rotatably connected to the power shaft 114 and rigidly attached to the housing 107.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. An apparatus for converting linear reciprocal motion to rotary motion, comprising:
at least one reciprocating assembly comprising a reciprocating component and a reciprocating rod capable of said linear reciprocal motion in unison, wherein said reciprocating component is rigidly attached to said reciprocating rod along a vertical axis of said reciprocating rod, wherein said reciprocating component is supported by a housing, and wherein said reciprocating rod is slidably connected to an idler gear via a guide pin;
a plurality of gear racks disposed on said reciprocating rod for transmitting motion to one or more of a plurality of gearing elements; and
said one or more gearing elements disposed on opposing sides of said reciprocating rod, wherein said gearing elements are in alternate mesh with said gear racks on said opposing sides of said reciprocating rod to transmit said motion to said idler gear, wherein each of said gearing elements and each of said gear racks together define a fixed moment arm, and wherein said gearing elements mesh with said idler gear rigidly mounted on a power shaft to convert said linear reciprocal motion of said reciprocating assembly to rotary motion of said power shaft, said power shaft being rotatably supported by said housing.

2. The apparatus of claim 1, wherein a centric axis of said idler gear is collinear to a longitudinal axis of said power shaft.

3. The apparatus of claim 1, wherein said each of said gearing elements comprises a partial gear area on a first section of its width and a full gear area on a second section of its width, wherein said partial gear area on said each of said gearing elements is in mesh with one of said gear racks on said reciprocating rod, and wherein said full gear area on said each of said gearing elements is in mesh with said idler gear.

4. The apparatus of claim 1, wherein said each of said gearing elements is rigidly mounted on a shaft rotatably supported by said housing.

5. The apparatus of claim 1, wherein said gear racks and said gearing elements are constructed in one of a spur gear configuration, a helical gear configuration, and a herringbone gear configuration.

6. The apparatus of claim 1, wherein said reciprocating component is a piston.

7. The apparatus of claim 1, wherein said reciprocating rod comprises an elongated aperture along said vertical axis of said reciprocating rod, wherein said guide pin is disposed within said elongated aperture to slidably connect said reciprocating rod to said idler gear.

8. The apparatus of claim 1, wherein each of said gear racks is one of integrated on said reciprocating rod and externally attached to said reciprocating rod.

9. The apparatus of claim 1, further comprising at least one transfer roller rotatably connected to said reciprocating rod, wherein said transfer roller assists in alternation of said mesh of said gear racks with said each of said gearing elements.

10. The apparatus of claim 9, further comprising a top recess and a bottom recess on said reciprocating rod on a locus of rotation of said transfer roller, to allow passage of said transfer roller through said reciprocating rod.

11. The apparatus of claim 1, further comprising at least one transfer roller rotatably attached to said idler gear to alternate said mesh of said gear racks with said each of said gearing elements.

12. The apparatus of claim 1, further comprising one or more idler gears rigidly mounted on said power shaft.

13. The apparatus of claim 1, further comprising a stabilizing fixture rotatably connected to said power shaft and rigidly attached to said housing to operatively reduce vibrations within said apparatus.

14. A method of converting linear reciprocal motion to rotary motion, comprising:
providing an apparatus comprising:
at least one reciprocating assembly comprising a reciprocating component and a reciprocating rod capable of said linear reciprocal motion in unison, wherein said reciprocating component is rigidly attached to said reciprocating rod along a vertical axis of said reciprocating rod, wherein said reciprocating component is supported by a housing, and wherein said reciprocating rod is slidably connected to an idler gear via a guide pin; wherein said rigid attachment of said reciprocating component to said reciprocating rod enables said linear reciprocal motion of said reciprocating assembly;
a plurality of gear racks disposed on said reciprocating rod; and
one or more gearing elements disposed on opposing sides of said reciprocating rod, wherein said gearing elements are in alternate mesh with said gear racks on said opposing sides of said reciprocating rod, wherein each of said gearing elements and each of said gear racks together define a fixed moment arm, and wherein said gearing elements mesh with said idler gear rigidly mounted on a power shaft, said power shaft being rotatably supported by said housing;
generating said linear reciprocal motion of said reciprocating assembly in response to a combustion force, wherein said linear reciprocal motion of said reciprocating assembly enables transmission of said combustion force to said gearing elements via said gear racks, wherein said gear racks convert said combustion force to a motion;
transmitting said converted motion to said gearing elements in said alternate mesh with said gear racks on said opposing sides of said reciprocating rod to rotate said gearing elements, wherein said rotation of said gearing elements causes rotation of said idler gear meshed to said gearing elements; and
rotating said power shaft by said rotation of said idler gear rigidly mounted on said power shaft;
whereby said rotary motion is generated at said power shaft of said apparatus.

15. The method of claim 14, wherein said each of said gearing elements comprises a partial gear area on a first section of its width and a full gear area on a second section of its width, wherein said each of said gearing elements is disposed alongside and in said alternate mesh with said gear racks on said reciprocating rod through said partial gear area while said full gear area on said each of said gearing elements is constantly in mesh with said idler gear during operation of said apparatus.

16. The method of claim 14, wherein a centric axis of said each of said gearing elements is parallel to a centric axis of said idler gear during operation of said apparatus.

17. The method of claim 14, wherein said gearing elements are disposed in a predetermined configuration to enable said alternate meshing of said gearing elements with said gear racks on said opposing sides of said reciprocating rod and to enable constant meshing of said gearing elements with said idler gear during operation of said apparatus.

18. The method of claim 14, further comprising operatively reducing vibrations within said apparatus using a stabilizing fixture rotatably connected to said power shaft and rigidly attached to said housing.

19. The method of claim 14, further comprising alternating said mesh of said gear racks with said each of said gearing elements using a transfer roller rotatably connected to one of said reciprocating rod and said idler gear.
